(19) United States
(12) Patent Application Publication
(10) Pub. No.: US 2021/0158703 A1
(43) Pub. Date: May 27, 2021

(54) INFORMATION PROCESSING DEVICE, INFORMATION PROCESSING SYSTEM, AND COMPUTER READABLE RECORDING MEDIUM

(71) Applicant: TOYOTA JIDOSHA KABUSHIKI KAISHA, Toyota-shi (JP)

(72) Inventors: Naoki UENOYAMA, Nagoya-shi (JP); Kazuya NISHIMURA, Anjo-shi (JP); Hikaru GOTOH, Nagoya-shi (JP)

(73) Assignee: TOYOTA JIDOSHA KABUSHIKI KAISHA, Toyota-shi (JP)

(21) Appl. No.: 17/071,394

(22) Filed: Oct. 15, 2020

(30) Foreign Application Priority Data
Nov. 26, 2019 (JP) 2019-213691

(51) Int. Cl. G08G 1/14; G01C 21/34; G01C 21/36

(52) U.S. Cl. CPC G08G 1/143; G01C 21/3626; G01C 21/3461

(57) ABSTRACT

An information processing device includes: a processor including hardware, the processor being configured to: acquire a plurality of pieces of area information from a sensor; acquire, in response to a request signal received from at least one of a user terminal associated with a user of a vehicle and a communication terminal associated with the vehicle, vehicle information including dimension information of the vehicle; and select, from the plurality of pieces of area information based on the vehicle information, area information indicating a position where the vehicle can be parked.

The present application claims priority to and incorporates by reference the entire contents of Japanese Patent Application No. 2019-213691 filed in Japan on Nov. 26, 2019.

### BACKGROUND

The present disclosure relates to an information processing device, an information processing system, and a computer readable recording medium.

It is often necessary to park a vehicle on a certain road where parking of the vehicle is permitted or in an open space on a road.

### SUMMARY

In a case where many vehicles are already parked in a certain area such as the certain road or the open space, it is difficult to find a parking available area having a predetermined parking space.

There is a need for an information processing device, information processing system, and a computer readable recording medium that may promptly retrieve an area suitable for parking of a vehicle on which a user rides in a parking available area such as a certain road or area where parking is permitted.

According to one aspect of the present disclosure, there is provided an information processing device including: a processor including hardware, the processor being configured to: acquire a plurality of pieces of area information from a sensor; acquire, in response to a request signal received from at least one of a user terminal associated with a user of a vehicle and a communication terminal associated with the vehicle, vehicle information including dimension information of the vehicle; and select, from the plurality of pieces of area information based on the vehicle information, area information indicating a position where the vehicle can be parked.

According to another aspect of the present disclosure, there is provided an information processing system including: a first device including a first processor including hardware, the first processor being configured to acquire a plurality of pieces of area information from a sensor; a second device including a second processor including hardware, the second processor being configured to acquire vehicle information including a dimension of a vehicle in response to a request signal received from at least one of a user terminal associated with a user of the vehicle and a communication terminal associated with the vehicle; and a third device including a third processor including hardware, the third processor being configured to select, from the plurality of pieces of area information based on the vehicle information, area information indicating a position where the vehicle can be parked.

### BRIEF DESCRIPTION OF THE DRAWINGS

FIG. 1 is a configuration diagram illustrating an information processing system according to an embodiment;

FIG. 2 is a block diagram schematically illustrating a configuration of a parking position retrieval device according to the embodiment;

FIG. 3 is a block diagram schematically illustrating a configuration of a parking area sensor device according to the embodiment;

FIG. 4 is a block diagram schematically illustrating a configuration of a vehicle according to the embodiment;

FIG. 5 is a block diagram schematically illustrating a configuration of a user terminal device according to the embodiment;

FIG. 6 is a sequence diagram illustrating an information processing system according to the embodiment;

FIG. 7 is a top view illustrating an example of parallel parking in a parking area according to the embodiment; and

FIG. 8 is a top view illustrating an example of double parking in a parking area according to the embodiment.

### DETAILED DESCRIPTION

Hereinafter, an embodiment of the present disclosure will be described with reference to the drawings. Note that the same reference sign is assigned to the same or corresponding parts in all the drawings of the following embodiment. Moreover, the present disclosure is not limited by the embodiment described below.

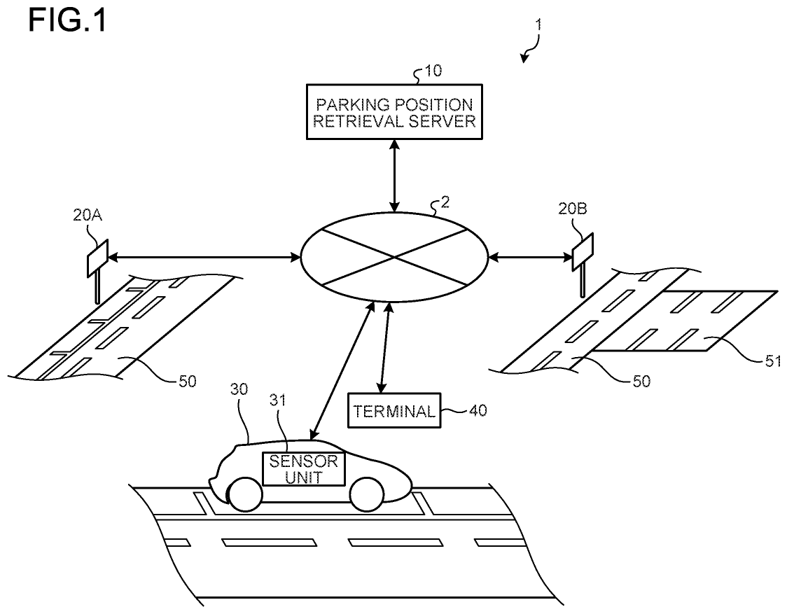

First, a parking position retrieval system that is an information processing system according to an embodiment of the present disclosure will be described. FIG. 1 is a schematic diagram illustrating a parking position retrieval system 1 according to this embodiment. As illustrated in FIG. 1, the parking position retrieval system 1 includes a parking position retrieval server 10, a parking sensor device 20, a vehicle 30 with a sensor unit 31, and a user terminal device 40 that are capable of communicating with each other via a network 2.

The network 2 includes an internet network, a mobile phone network, and the like. The network 2 is, for example, a public communication network such as the Internet, and may include other communication networks such as a wide area network (WAN), a telephone communication network of a mobile phone or the like, and a wireless communication network such as WiFi (registered trademark).

The parking position retrieval server 10 as a parking position retrieval device that is an information processing device is, for example, a processing server owned by a navigation service provider that provides a navigation service to a vehicle 30, an information provider that provides predetermined information to the vehicle 30, or the like. That is, the parking position retrieval server 10 generates and manages information provided to the vehicle 30.

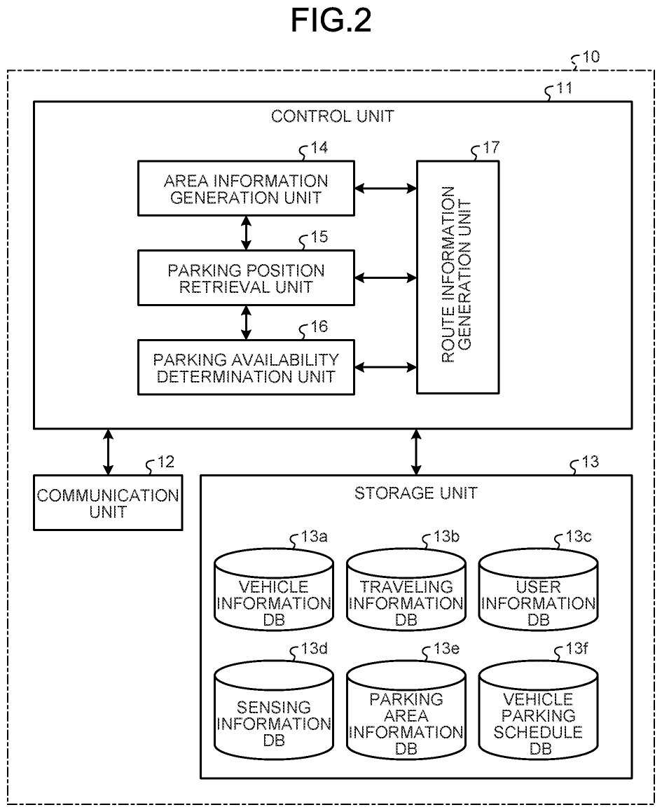

FIG. 2 is a block diagram schematically illustrating a configuration of the parking position retrieval server 10. As illustrated in FIG. 2, the parking position retrieval server 10 includes a computer that has general hardware and that may perform communication via the network 2. The parking position retrieval server 10 includes a control unit 11, a communication unit 12, and a storage unit 13 that stores various databases. The control unit 11 includes an area information generation unit 14, a parking position retrieval unit 15, a parking availability determination unit 16, and a route information generation unit 17.

More specifically, the control unit 11 includes a processor such as a central processing unit (CPU), a digital signal processor (DSP), or a field-programmable gate array (FPGA), and a main storage unit such as a random access memory (RAM) or a read only memory (ROM). The storage unit 13 includes a storage medium selected from an erasable programmable ROM (EPROM), a hard disk drive (HDD), a removable medium, and the like. Note that a removable medium is, for example, a universal serial bus (USB) memory or a disc recording medium such as a compact disc (CD), a digital versatile disc (DVD), or a Blu-ray (registered trademark) disc (BD). The storage unit 13 may store an operating system (OS), various programs, various tables, various databases, and the like. The control unit 11 loads and executes a program stored in the storage unit 13 in a work area of the main storage unit, and controls each component or the like through the execution of the program. As a result, the control unit 11 may realize functions of the area information generation unit 14, the parking position retrieval unit 15, the parking availability determination unit 16, and the route information generation unit 17 corresponding to a predetermined purpose.

The communication unit 12 as an information acquisition unit is, for example, a local area network (LAN) interface board, or a wireless communication circuit for wireless communication. The LAN interface board or the wireless communication circuit is connected to the network 2, such as the Internet, as a public communication network. The communication unit 12 is connected to the network 2 and communicates with parking sensor devices 20A and 20B (hereinafter, also referred to as parking sensor device 20), the vehicle 30, and the user terminal device 40.

The communication unit 12 receives various kinds of information such as parking position information from the parking sensor device 20, and transmits, to the parking sensor device 20, a request signal requesting for transmission of predetermined parking position information. With respect to a user terminal device 40 owned by a user, the communication unit 12 transmits information to the user terminal device 40 in utilization of the vehicle 30, and receives user identification information for identification of the user, and various kinds of information from the user terminal device 40.

The communication unit 12 receives various kinds of information such as vehicle identification information, traveling information, and vehicle information from each vehicle 30, and transmits an instruction signal to the vehicle 30. The vehicle identification information includes unique information enabling identification of each vehicle 30. The traveling information is information related to traveling. The traveling information may include positional information, traveling route information, traveling schedule information, parking schedule information, and traveling history information, but is not necessarily limited to these pieces of information. The traveling information may further include various kinds of information related to traveling of the vehicle 30, such as speed information, acceleration information, traveling distance information, and traveling time information. Note that in a case where the vehicle 30 travels on a predetermined route set in advance, the traveling information may include operation information. The vehicle information may include information related to dimensions of the vehicle 30 (hereinafter, vehicle dimension information), a state of charge (SOC), a remaining fuel amount, and information related to a condition of the vehicle 30 (hereinafter, vehicle condition information), but is not necessarily limited thereto. In a case where the vehicle 30 is a rented car or the like, the vehicle information may further include information indicating existence/non-existence of a user that is a borrower, and user identification information of a user that borrows and rides on the vehicle in a case where there is the user that borrows the vehicle.

The storage unit 13 includes various databases including a relational database (RDB), for example. Note that a program of a database management system (DBMS) executed by the above-described processor manages data stored in the storage unit 13, whereby each database (DB) described below is constructed. The storage unit 13 includes a vehicle information database 13a, a traveling information database 13b, a user information database 13c, a sensing information database 13d, a parking area information database 13e, and a vehicle parking schedule database 13f.

Vehicle information that includes vehicle dimension information, vehicle condition information, and the like of each vehicle 30 and that is received from the vehicle 30 is stored in the vehicle information database 13a in an updatable manner in association with the vehicle identification information. Traveling information of each vehicle 30 which information is received from the vehicle 30 is stored in the traveling information database 13b in an updatable manner in association with the vehicle identification information.

In the user information database 13c, the user identification information and user information related to a user may be stored retrievably in association with each other. The user information may include various kinds of information input or selected by the user (hereinafter, user selection information) or information related to driving skill of the user (skill information). The user selection information may include, in addition to the information of an item selected by each user, information related to a start or end of a rental of the vehicle 30 by the user, information of a basic rent set for each user, and the like in a case where the vehicle 30 is a rented car. The skill information is associated with the user identification information as information of a driving skill level of the user which level is measured when the user drives the vehicle 30, that is, as information of a driving skill of the user, and is stored retrievably in the user information database 13c.

The user identification information is stored in the user information database 13c in a retrievable state when assigned to the user. The user identification information includes various kinds of information for identification of each individual user. The user identification information is, for example, a user ID with which individual user may be identified, and is registered in association with user-specific information such as a name and address of the user, or positional information such as longitude and latitude indicating a position or the like of the user. That is, the user identification information includes information necessary to access the parking position retrieval server 10 in transmission/reception of information related to the user. For example, the vehicle 30 or the user terminal device 40 transmits predetermined information such as the user selection information or skill information to the parking position retrieval server 10 together with the user identification information. In this case, the parking position retrieval server 10 stores the received information retrievably in the user information database 13c of the storage unit 13 in association with the user identification information.

The vehicle identification information is stored in a retrievable state in the vehicle information database 13a and the traveling information database 13b after being assigned to the vehicle 30. The vehicle identification information includes various kinds of information for identification of each individual vehicle 30. When the vehicle 30 transmits predetermined information such as positional information or vehicle information to the parking position retrieval server 10 together with the vehicle identification information, the parking position retrieval server 10 stores the predetermined information in a retrievable state in the storage unit 13 in association with the vehicle identification information. In this case, the predetermined information such as positional information or vehicle information may be stored in the vehicle information database 13a or the traveling information database 13b.

The sensing information database 13d stores sensing information that is related to a parking space and transmitted from the parking sensor device 20 or the vehicle 30. As described later, the sensing information includes a captured image and sensing data of a parking space in a predetermined area imaged by the parking sensor device 20. Similarly, the sensing information includes a captured image and sensing data related to a road 50 or a vacant lot (or an open space) 51 imaged by the sensor unit 31 of the vehicle 30.

The parking area information database 13e retrievably stores information related to parking areas such as a parking available space on the road 50 and a parking available vacant lot 51 adjacent to the road 50 (hereinafter, parking area information). The parking area information includes, for example, information of a parking space in which the vehicle 30 is parked on the road 50 or in the vacant lot 51, and a parking space in which no vehicle 30 is parked and which is vacant. With respect to these parking spaces, the parking area information includes necessary information selected from a position, size, area, a width of the road 50, a road width of an adjacent road 50, and the like. The parking position retrieval server 10 periodically acquires sensing information or parking area information from each parking sensor device 20 or each vehicle 30. Note that the sensing information and the parking area information correspond to area information. In a case where the parking position retrieval server 10 acquires the parking area information, the acquired parking area information is retrievably stored in the parking area information database 13e.

In the vehicle parking schedule database 13f, information of a schedule of parking of each vehicle 30, more specifically, information of a parking position and information of a parking time period are stored in association with the vehicle identification information. In the present description, the information of a parking position and the information of a parking time period are collectively referred to as parking schedule information.

The area information generation unit 14 generates and acquires parking area information based on the sensing information stored in the sensing information database 13d. The area information generation unit 14 acquires the parking area information by generation thereof from the sensing information by information processing according to a predetermined program. Note that the area information generation unit 14 may include a learned model generated by machine learning. Here, the learned model may be a learned model generated with input/output data sets having predetermined sensing information as an input parameter and predetermined parking area information as an output parameter being teacher data.

Based on the parking area information stored in the parking area information database 13e, the parking position retrieval unit 15 retrieves parking area information indicating that other vehicles 30A and 30B are not parked or are scheduled to depart within a predetermined period (hereinafter, vacant area information). The parking position retrieval unit 15 inputs the retrieved vacant area information to the parking availability determination unit 16 and the route information generation unit 17. Note that the vacant area information may be generated by the parking sensor device 20 or the vehicle 30 and transmitted to the parking position retrieval server 10. In this case, a load on retrieval processing by the parking position retrieval server 10 may be reduced.

The parking availability determination unit 16 determines whether the vehicle 30 may be parked in a parking space indicated by the vacant area information based on the parking area information, more specifically, the vacant area information retrieved or acquired by the parking position retrieval unit 15, and the vehicle information, more specifically, the vehicle dimension information acquired from the vehicle 30. Note that the parking availability determination unit 16 may determine whether parking is possible by further using skill information of a user driving the vehicle 30 (own-vehicle skill information) other than the parking area information and the vehicle information. A result of the determination whether parking is possible which determination is made by the parking availability determination unit 16 is supplied as parking availability information to the route information generation unit 17. Note that the parking position retrieval unit 15 and the parking availability determination unit 16 may be made to work together and supply the parking area information, the vacant area information, and the parking availability information to the route information generation unit 17 in association with the user identification information. Note that the parking availability determination unit 16 may include a learned model generated by machine learning. Here, the learned model may be generated by machine learning with input/output data sets of predetermined input parameters and output parameters being teacher data. As the input parameter, for example, necessary information among parking area information including predetermined vacant area information, driving skill information of various users, and various kinds of schedule information is selected. The output parameter may be a determination result indicating whether parking is possible.

The route information generation unit 17 generates route information based on the parking area information, more specifically, the vacant area information acquired from the parking position retrieval unit 15, and the parking availability information acquired from the parking availability determination unit 16. The route information includes information of a travelable route from a current position of the vehicle 30 or a position intended by a user to a position of a parking space included in the vacant area information and determined that parking is possible. The route information generation unit 17 stores the generated route information into the traveling information database 13b. On the other hand, the route information generation unit 17 transmits the generated route information to at least one of the vehicle 30 and the user terminal device 40 via the communication unit 12.

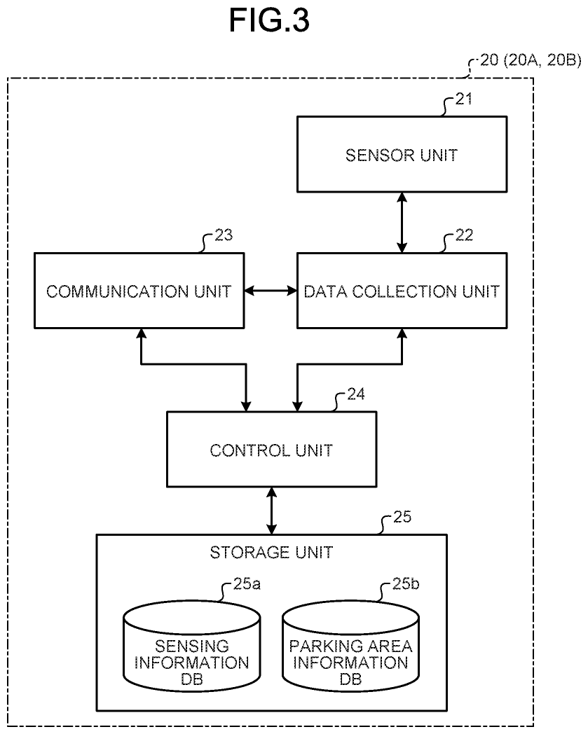

The parking sensor devices 20 (20A and 20B) illustrated in FIG. 1 acquire information of a parking available area on the road 50 or an area such as a parking available vacant lot 51 adjacent to the road 50, for example, by sensing processing such as imaging. FIG. 3 is a block diagram schematically illustrating a configuration of a parking sensor device 20. As illustrated in FIG. 3, the parking sensor device 20 has a configuration with which communication is possible via the network 2. The parking sensor device 20 includes a sensor unit 21, a data collection unit 22, a communication unit 23, a control unit 24, and a storage unit 25.

For example, the sensor unit 21 includes an imaging device such as an imaging camera that may image a predetermined area, a millimeter-wave radar or a laser radar that may perform scanning electronically with a beam and may detect existence/non-existence of an obstacle, and the like. The data collection unit 22 is a processing unit that controls the sensing processing performed by the sensor unit 21, and a result of the sensing processing executed by the sensor unit 21 is processed by the data collection unit 22 and becomes sensing information. The sensing information processed by the data collection unit 22 is retrievably stored in a sensing information database 25a of the storage unit 25. Note that the data collection unit 22 may further include a storage unit. Moreover, the data collection unit 22 and the sensor unit 21 may be configured separately from the communication unit 23, the control unit 24, and the storage unit 25.

The communication unit 23 is physically similar to the communication unit 12 described above. The communication unit 23 is connected to the network 2 and communicates with the parking position retrieval server 10. The communication unit 23 selects at least one of the sensing information, and the parking area information including the vacant area information and performs transmission thereof to the parking position retrieval server 10. Note that information transmitted by the communication unit 23 is not limited to these pieces of information.

The control unit 24 and the storage unit 25 are physically similar to the control unit 11 and the storage unit 13 described above, respectively. In the storage unit 25, sensing information related to a parking area sensed by the sensor unit 21 is stored as the sensing information database 25a. The control unit 24 may generate parking area information by executing image processing or information processing on the sensing information acquired from the data collection unit 22 and stored in the sensing information database 25a of the storage unit 25. The parking area information includes information related to a space in which the vehicle 30 is parked and information related to a space in which no vehicle 30 is parked in the area where the sensor unit 21 performs the sensing processing. The space where no vehicle 30 is parked is included as vacant area information in the parking area information. In this case, the storage unit 25 may store a parking area information database 25b that stores the parking area information generated by the control unit 24.

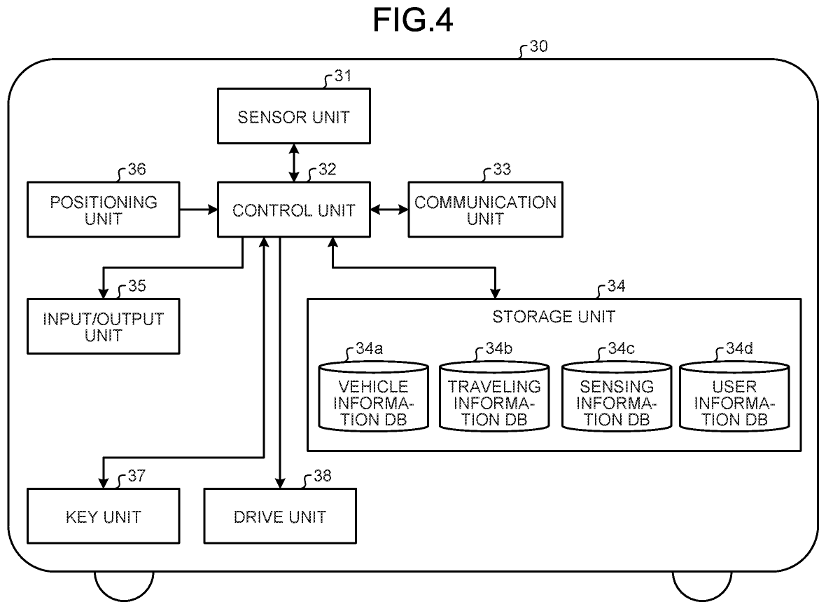

The vehicle 30 as a mobile object is a vehicle that travels by driving by a driver, or an autonomous traveling vehicle capable of traveling autonomously according to a given traveling command. FIG. 4 is a block diagram schematically illustrating a configuration of the vehicle 30. As illustrated in FIG. 4, the vehicle 30 includes a sensor unit 31, a control unit 32, a communication unit 33, a storage unit 34, an input/output unit 35, a positioning unit 36, a key unit 37, and a drive unit 38.

The sensor unit 31 includes a sensor that is related to traveling of the vehicle 30 and that is, for example, a vehicle speed sensor or an acceleration sensor, a vehicle interior sensor that may detect various conditions in the vehicle interior, an imaging device that may photograph the vehicle interior or the vehicle exterior and that is, for example, an imaging camera, and the like. In the present embodiment, for example, the imaging device images a scene in the vehicle exterior, whereby image data as sensing information is accumulated in the storage unit 34. Note that the sensing information is not limited to image data as long as information of a parking area on the road 50 or in the vacant lot 51 adjacent to the road 50 may be acquired.

The control unit 32, the communication unit 33, and the storage unit 34 are physically similar to the control unit 11, the communication unit 12, and the storage unit 13 described above, respectively. The control unit 32 integrally controls operations of various components mounted on the vehicle 30. The communication unit 33 as a communication terminal of the vehicle 30 includes, for example, a data communication module (DCM) or the like that communicates with the parking position retrieval server 10 or the parking sensor device 20 by wireless communication via the network 2.

The storage unit 34 includes a vehicle information database 34a, a traveling information database 34b, a sensing information database 34c, and a user information database 34d. The vehicle information database 34a stores, in an updatable manner, various kinds of information including an SOC, a remaining fuel amount, vehicle dimension information, and the like. The traveling information database 34b stores, in an updatable manner, various kinds of information including traveling information measured and generated by the control unit 32 based on various kinds of information acquired from the sensor unit 31, the positioning unit 36, and the drive unit 38. In the sensing information database 34c, data of a captured image captured by the sensor unit 31, sensing data that is a result of sensing by the sensor unit 31, and the like are stored in a superimposable or rewritable manner.

The input/output unit 35 includes a touch panel display, a speaker microphone, and the like. According to control by the control unit 32, the input/output unit 35 as an output unit may notify the outside of predetermined information by displaying a character, figure, and the like on a screen of the touch panel display, or outputting sound from the speaker microphone. Moreover, the input/output unit 35 as an input unit may input predetermined information to the control unit 32 when a user or the like operates the touch panel display or emits sound toward the speaker microphone.

For example, the positioning unit 36 receives a radio wave from a global positioning system (GPS) satellite and detects a position of the vehicle 30. A position or route of the vehicle 30 which position or route is detected by the positioning unit 36 functioning as a positional information acquisition unit of the vehicle 30 is stored retrievably in the vehicle information database 34a as positional information or traveling route information in the traveling information. Note that a method in which light detection and ranging/laser imaging detection and ranging (LiDAR) is combined with a three-dimensional digital map may be employed as a method of detecting a position of the vehicle 30.

Note that although including the input/output unit 35 and the positioning unit 36 as separate functions, the vehicle 30 according to the present embodiment may include, instead of the input/output unit 35 and the positioning unit 36, an in-vehicle navigation system with a communication function which system has both of functions of the input/output unit 35 and the positioning unit 36.

The key unit 37 may execute locking or unlocking of the vehicle 30, for example, by authentication with the user terminal device 40 based on BLE authentication information. The drive unit 38 is a conventionally known drive unit necessary for traveling of the vehicle 30. Specifically, the vehicle 30 includes an engine as a drive source, and the engine may generate electric power with an electric motor or the like by driving due to combustion of fuel. The generated electric power is charged in a rechargeable battery. Moreover, the vehicle 30 includes a drive transmission mechanism that transmits driving force of the engine, driving wheels for traveling, and the like.

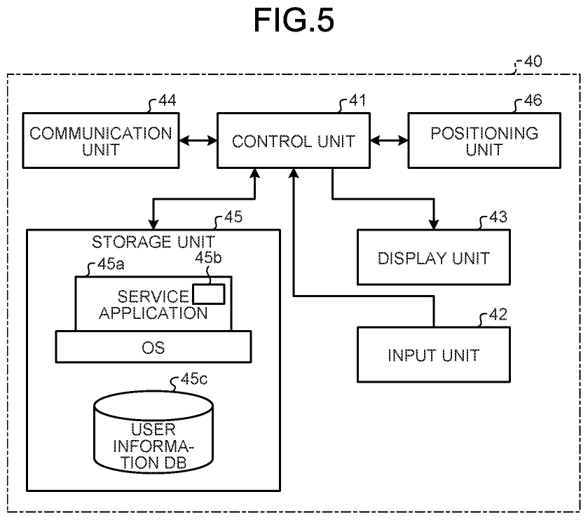

The user terminal device 40 as a terminal is operated by a user. The user terminal device 40 transmits various kinds of information such as user information including user identification information and user selection information to the parking position retrieval server 10, for example, by a call by a communication application using various kinds of data or sound. From the parking position retrieval server 10, the user terminal device 40 may receive various kinds of information such as traveling route information and, when necessary, electronic key data. Note that the user terminal device 40 may be an in-vehicle terminal fixed to the vehicle 30, a mobile terminal that may be carried by a user, or a terminal that may be attached/detached at a predetermined portion of the vehicle 30. FIG. 5 is a block diagram schematically illustrating a configuration of the user terminal device 40 illustrated in FIG. 1.

As illustrated in in FIG. 5, the user terminal device 40 includes a control unit 41, an input unit 42, a display unit 43, a communication unit 44, a storage unit 45, and a positioning unit 46 that are communicably connected to each other. The control unit 41, the communication unit 44, and the storage unit 45 are physically similar to the control unit 11, the communication unit 12, and the storage unit 13 described above, respectively. The positioning unit 46 is physically similar to the positioning unit 36 described above.

The control unit 41 may execute various programs stored in the storage unit 45, and may store various tables, various databases, and the like in the storage unit 45. The control unit 41 loads and executes an OS and a service application 45a stored in the storage unit 45 in a work area of a main storage unit, and integrally controls operations of the input unit 42, the display unit 43, the communication unit 44, the storage unit 45, and the positioning unit 46. In the present embodiment, a locking/unlocking request program 45b is embedded into the service application 45a, for example, in a form of a software development kit (SDK).

The locking/unlocking request program 45b is executed by the service application 45a of the user terminal device 40 and, for example, authentication based on BLE authentication information is performed between the user terminal device 40 and the key unit 37, whereby the vehicle 30 may be locked or unlocked. This allows the vehicle 30 to acquire user information of a user driving the vehicle 30. Note that various conventionally known methods may be employed for the locking/unlocking of the vehicle 30 via communication between the user terminal device 40 and the key unit 37.

The input unit 42 includes, for example, a keyboard, a touch panel keyboard that is embedded in the display unit 43 and that detects a touch operation on a display panel, a sound input device that enables a call with the outside, or the like. Here, the call with the outside not only includes a call with another user terminal device 40 but also includes, for example, a call with an operator that operates the parking position retrieval server 10 or with an artificial intelligence system.

The display unit 43 includes, for example, an organic EL panel, a liquid crystal display panel, or the like and notifies the outside of information by displaying a character, a figure, and the like on the display panel. Note that the input unit 42 and the display unit 43 may be configured similarly to the input/output unit 35 described above.

The communication unit 44 may transmit/receive various kinds of information such as the user identification information, the user selection information, and sound data to/from an external server such as the parking position retrieval server 10, or the vehicle 30 via the network 2. The storage unit 45 has a user information database 45c and may store the user information in association with the user identification information. The positioning unit 46 as a positional information acquisition unit of the user terminal device 40 may detect a position of the user terminal device 40, for example, by communication with a GPS satellite. The detected positional information may be transmitted to the parking position retrieval server 10 or the vehicle 30 via the network 2 as user position information in association with the user identification information.

As the user terminal device 40 described above, specifically, various devices that may be carried by a user and that are, for example, a mobile phone such as a smartphone, a tablet-type information terminal, and the like may be used. Moreover, the user terminal device 40 may be an in-vehicle terminal fixed to the vehicle 30, a mobile terminal that may be carried by a user, or an operation terminal that may be attached/detached at a predetermined portion of the vehicle 30.

Next, a parking area retrieval method executed by the parking position retrieval server 10 of the parking position retrieval system 1 configured in the above manner will be described. In the following description, transmission and reception of information are performed via the network 2, but repetitive description on this point is omitted. Moreover, in a case where information is transmitted from each vehicle 30 or each user terminal device 40, vehicle identification information and user identification information for identification of the vehicle 30 or the user terminal device 40 are also transmitted in association with the transmitted information. However, repetitive description on this point is also omitted.

In Step ST1, the vehicle 30 periodically transmits sensing information such as image data captured, for example, by an imaging device or the like of the sensor unit 31 to the parking position retrieval server 10. Similarly, in Step ST2, the parking sensor device 20 periodically transmits sensing information such as image data in a predetermined area imaged, for example, by an imaging device or the like of the sensor unit 21 to the parking position retrieval server 10. Step ST1 and ST2 are periodically executed in the parking area retrieval method, and may be executed in reverse order or in parallel. The parking position retrieval server 10 that acquires the sensing information stores the acquired sensing information in the sensing information database 13d.

Then, the parking position retrieval server 10 make a transition to Step ST3, and causes the area information generation unit 14 of the control unit 11 to generate parking area information based on the sensing information. The parking area information includes information of a parking space in which the vehicle 30 is parked and a parking space in which no vehicle 30 is parked and which is vacant on the road 50 or in a vacant lot 51 as a certain area.

When a transition to Step ST4 is made and a user of the vehicle 30 inputs information to request for parking of the vehicle 30 to the input/output unit 35 as user selection information, the control unit 32 transmits a parking request signal to the parking position retrieval server 10 via the communication unit 33. Moreover, as in Step ST5, a user of the user terminal device 40 may input information to request for parking of the vehicle 30 to the input unit 42 as user selection information, and the control unit 41 may transmit a parking request signal to the parking position retrieval server 10 via the communication unit 44. Note that the user terminal device 40 is associated with the vehicle 30 by the key unit 37 of the vehicle 30.

Subsequently, in Step ST6, the control unit 32 of the vehicle 30 transmits vehicle information including vehicle dimension information to the parking position retrieval server 10. Here, the control unit 32 of the vehicle 30 may also transmit user information including skill information (own-vehicle skill information), and traveling information including parking schedule information of the vehicle 30 (own-vehicle traveling information) to the parking position retrieval server 10. On the other hand, in Step ST7, traveling information including parking schedule information of other vehicles 30A and 30B (other-vehicle traveling information) is appropriately transmitted from the other vehicles 30A and 30B to the parking position retrieval server 10. The parking schedule information includes information of scheduled departure time of the vehicle 30 and the other vehicles 30A and 30B. Here, the other vehicles 30A and 30B may also transmit user information including skill information of users driving the other vehicles 30A and 30B (other-vehicle skill information) respectively to the parking position retrieval server 10.

Note that for the sake of convenience, skill information of a user that drives the vehicle 30 that transmits the parking request signal is called own-vehicle skill information, and skill information of users that drive other vehicles (such as other vehicle 30A and 30B) is called other-vehicle skill information. However, the both are pieces of information related to driving skill of each user. Similarly, for the sake of convenience, traveling information of the vehicle 30 that transmits the parking request signal is called own-vehicle traveling information, and traveling information of other vehicles (such as other vehicle 30A or 30B) is called other-vehicle traveling information. However, the both are pieces of information related to traveling of the vehicles.

A transition to Step ST8 is made, and the parking position retrieval unit 15 of the parking position retrieval server 10 retrieves vacant area information including information on a parking space that is vacant (hereinafter, vacant parking space) from the parking area information database 13e. Here, more specifically, the vacant parking space is as follows. That is, first, the vacant parking space is a parking space in which the other vehicle 30A is not parked based on the vacant area information. Moreover, second, the vacant parking space is a parking space in which the other vehicle 30A is currently parked but the other vehicle 30A departs before the vehicle 30 moves to a target parking space, that is, in a predetermined period based on the parking schedule information of the other vehicle 30A. Moreover, the retrieval may be limited to a position within a predetermined distance from a current position of the vehicle 30 or within a range that may be reached within a predetermined period.

The parking position retrieval unit 15 performs retrieval in the storage unit 13, and retrieves information of a parking space that is vacant (hereinafter, vacant parking space) based on parking area information, current positional information of the vehicle 30, and parking schedule information of the other vehicle 30A. Accordingly, the parking position retrieval unit 15 may determine whether there is a vacant parking space. In a case where the parking position retrieval unit 15 determines that there is no vacant parking space (Step ST9: NO), the parking position retrieval processing is ended. Here, the parking position retrieval unit 15 may input information that there is no vacant parking space to the parking availability determination unit 16. In this case, the parking availability determination unit 16 may transmit information indicating contents that “there is no vacant parking space” to the vehicle 30 or the user terminal device 40, and may cause the input/output unit 35 or the display unit 43 to output the information indicating contents that “there is no vacant parking space”. Moreover, the parking position retrieval unit 15 or the parking availability determination unit 16 may transmit information of time, at which a vacant parking space is generated, to the vehicle 30 based on scheduled departure time in the parking schedule information of the other vehicles 30A and 30B. As a result, scheduled time when the parking space becomes vacant may be output from the input/output unit 35 by the control unit 32 of the vehicle 30 and may be recognized by a user.

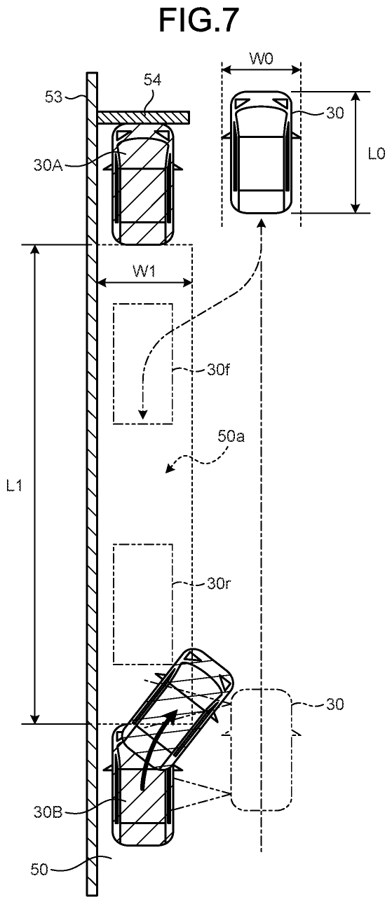

On the other hand, in a case where the parking position retrieval unit 15 determines that there is a vacant parking space (Step ST9: YES), the parking position retrieval unit 15 outputs vacant area information including information of all vacant parking spaces or one or more vacant parking spaces that meet a predetermined condition to the parking availability determination unit 16, and a transition to Step ST10 is made. In Step ST10, the parking availability determination unit 16 determines whether the vehicle 30 may be parked in a vacant parking space included in the acquired vacant area information. Note that the determination by the parking availability determination unit 16 whether parking is possible may be executed for all vacant parking spaces included in the vacant area information or executed for one or more vacant parking spaces that meet the predetermined condition. Here, an example in which the parking availability determination unit 16 determines whether parking is possible in a case where parallel parking is performed in one vacant parking space will be described. Note that in a case where determination is made for a plurality of vacant parking spaces, determination similar to the determination for one vacant parking space is serially performed for the vacant parking spaces. FIG. 7 is a top view illustrating an example of a case where the vehicle 30 performs parallel parking.

That is, information of a vacant parking space 50a which information is included in vacant area information retrieved with respect to the road 50 on which parallel parking is possible includes information of a length L1 defined by the other vehicles 30A and 30B, or other obstacles, a no-entry area, or the like for example, in a direction along the road 50 in the example illustrated in FIG. 7. Moreover, information of the vacant parking space 50a which information is included in the vacant area information includes information of a width W1 to a road shoulder 53 which width is defined by the other vehicles 30A and 30B, other obstacles, or a no-entry area in the example illustrated in FIG. 7. Accordingly, the parking availability determination unit 16 may determine whether parallel parking of the vehicle 30 in the vacant parking space 50a is possible by comparing the length L1 and the width W1 of the vacant parking space 50a with a vehicle length L0 and a vehicle width W0 of the vehicle 30, respectively. In this case, the parking availability determination unit 16 first derives a moving range of when the vehicle 30 performs parallel parking. In the example illustrated in FIG. 7, the vehicle 30 moves along a route indicated by a dashed-dotted line when performing parallel parking into the vacant parking space 50a. In this case, in order that the vehicle 30 may move along the moving route, a necessary range along the moving route, that is, a moving range is necessary. The parking availability determination unit 16 determines whether parking into the vacant parking space 50a is possible based on whether parallel parking may be performed without the derived moving range interfering with the other vehicles 30A and 30B, the other obstacles, or the no-entry area.

Moreover, the parking availability determination unit 16 may further determine whether the vehicle 30 may be parked in the vacant parking space 50a based on skill of a driver of the vehicle 30. In this case, in addition to the above-described determination whether parking is possible based on a width of the vacant parking space 50a, and a size and a moving range of the vehicle 30, the parking availability determination unit 16 determines whether parking is possible based on user information including skill information of a user that is the driver of the vehicle 30. More specifically, first, based on the skill information, the parking availability determination unit 16 derives a moving range of when the driver driving the vehicle 30 performs parallel parking. Next, the parking availability determination unit 16 determines whether parallel parking into the vacant parking space 50a may be performed without the derived moving range interfering with the other vehicles 30A and 30B, other obstacles, or no-entry area. Accordingly, the parking availability determination unit 16 may determine whether the vehicle 30 may be parked in the vacant parking space 50a based on driving skill of the user that drives the vehicle 30.

On the other hand, the parking availability determination unit 16 may determine whether the vehicle 30 may be parked into the vacant parking space 50a based on skill of drivers of the other vehicles 30A and 30B. In this case, in addition to the above-described determination whether parking is possible based on a width of the vacant parking space 50a, and a size and a moving range of the vehicle 30, the parking availability determination unit 16 determines whether parking is possible based on parking schedule information of the other vehicles 30A and 30B.

More specifically, first, the parking availability determination unit 16 derives a range in which the vehicle 30 may be parked in the vacant parking space 50a. In the example illustrated in FIG. 7, a position where the vehicle 30 may be parked is that a front side of the vehicle 30 is to a position of a rear end of the other vehicle 30A and a rear side of the vehicle 30 is to a position of a front end of the other vehicle 30B. In this case, for example, when the vehicle 30 is parked at a rear position extremely close to the front end of the other vehicle 30B, it becomes difficult for the other vehicle 30B depart while the vehicle 30 is parked.

Thus, the parking availability determination unit 16 compares scheduled departure time included in the parking schedule information of the vehicle 30 with scheduled departure time included in the parking schedule information of the other vehicle 30B. In a case where the scheduled departure time of the vehicle 30 is before the scheduled departure time of the other vehicle 30A, the parking availability determination unit 16 may determine that the position on the rear side extremely close to the front end of the other vehicle 30B is in a range available for parking. On the contrary, in a case where the scheduled departure time of the vehicle 30 is later than the scheduled departure time of the other vehicle 30A, the parking availability determination unit 16 derives a moving range of when the other vehicle 30B departs, and may determine that a range available for parking is to a position that does not interfere with the moving range of the other vehicle 30B. In the example illustrated in FIG. 7, the parking availability determination unit 16 sets a vehicle position 30r as the rearmost end of a range available for parking, for example.

Similarly, the parking availability determination unit 16 determines a range available for parking of the vehicle 30 based on the parking schedule information of each of the vehicle 30 and the other vehicle 30A. In the example illustrated in FIG. 7, an obstacle 54 exists in front of the other vehicle 30A. Thus, the range in which the vehicle 30 may be parked is to the position of the rear end of the other vehicle 30A or to a position that does not interfere with the moving range of the other vehicle 30A, more specifically, to a position of a vehicle position 30f. The parking availability determination unit 16 compares the scheduled departure time of the vehicle 30 and that of the other vehicle 30A, and determines to which position the range available for parking is set.

When deriving the moving ranges of the other vehicles 30A and 30B, the parking availability determination unit 16 may further derive moving ranges of the other vehicles 30A and 30B based on the skill information of the drivers that drive the other vehicles 30A and 30B. In this case, the above-described vehicle positions 30f and 30r also become different positions according to the moving ranges based on the skill information of the drivers of the other vehicles 30A and 30B. In a case where the vehicle 30 and the other vehicles 30A and 30B are vehicles capable of autonomous traveling or autonomous parking, the skill information may not be employed, or setting information by autonomous driving may be employed instead of the skill information.

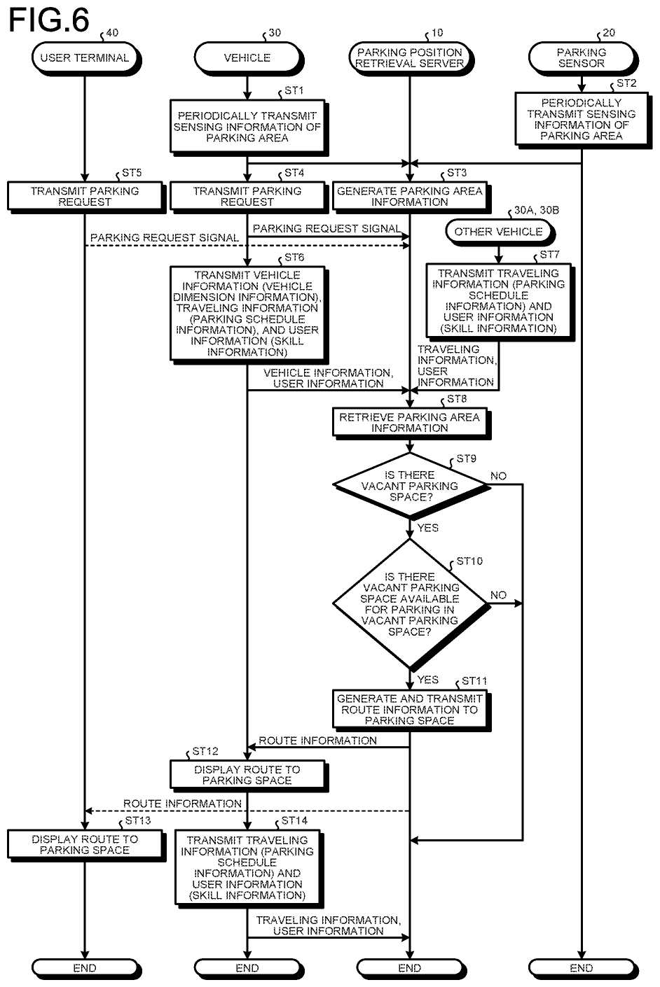

In the above manner, the parking availability determination unit 16 determines whether parking is possible. As a result, in a case where the parking availability determination unit 16 determines that parallel parking of the vehicle 30 into the vacant parking space 50a is not possible, the parking position retrieval processing is ended. Here, the parking availability determination unit 16 may transmit information indicating contents that “there is no vacant parking space available for parking” to the vehicle 30 or the user terminal device 40, and cause the input/output unit 35 or the display unit 43 to output the information indicating contents that “there is no parking space available for parking”. On the other hand, in a case where the parking availability determination unit 16 determines that parallel parking of the vehicle 30 into the vacant parking space 50a is possible, the parking availability determination unit 16 outputs the vacant area information including information of the vacant parking space 50a to the route information generation unit 17, and a transition to Step ST11 illustrated in FIG. 6 is made.

In Step ST11, the route information generation unit 17 retrieves a route from a current position of the vehicle 30 or a predetermined position selected by the user to a position of the vacant parking space 50a based on positional information of the vacant parking space 50a which information is included in the vacant area information. Note that in a case where the vacant area information includes information of a plurality of vacant parking spaces 50a, route information to each of the vacant parking spaces 50a is generated. The route information generation unit 17 transmits the generated route information to the vehicle 30 or the user terminal device 40 via the communication unit 12. Then, in Step ST12, the input/output unit 35 of the vehicle 30 outputs the route information to the vacant parking space 50a. Similarly, in Step ST13, the display unit 43 of the user terminal device 40 outputs the route information to the vacant parking space 50a. Only one of Step ST12 and ST13 may be executed, or execution thereof may be performed in sequence, in reverse order, or in parallel.

In Step ST14, the control unit 32 of the vehicle 30 appropriately transmits the traveling information including the parking schedule information of the vehicle 30 to the parking position retrieval server 10 via the communication unit 33, similarly to the other vehicles 30A and 30B in Step ST7. Here, the control unit 32 may also transmit the user information including the skill information of the user that drives the vehicle 30 to the parking position retrieval server 10. From the above, the parking position retrieval processing is ended. Note that Step ST1 to ST14 in the above may be appropriately repeated.

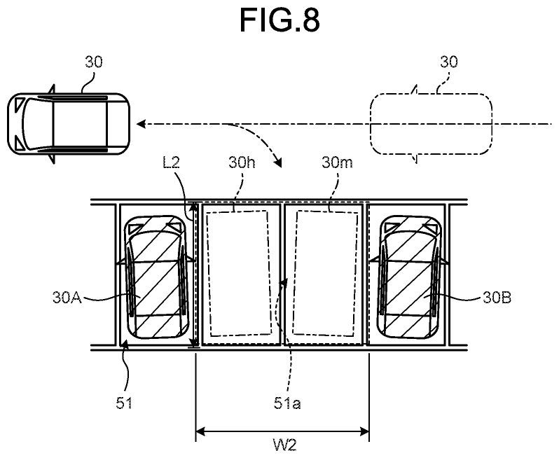

Next, an example of double parking in determination whether the vehicle 30 may be parked in Step ST10 of the above-described parking position retrieval method will be described. FIG. 8 is a top view illustrating an example of a case where the vehicle 30 performs double parking (garage parking).

With respect to the vacant lot 51 in which double parking is possible, information of a vacant parking space 51a which information is included in retrieved vacant area information includes, for example, information of a length L2 defined in a predetermined direction of the vacant lot 51, and by an arrangement direction of the other vehicles 30A and 30B, other obstacles, no-entry area, or the like in an example of FIG. 8. Moreover, in the example illustrated in FIG. 8, the information of the vacant parking space 51a which information is included in the vacant area information includes information of a width W2 which is defined by the other vehicles 30A and 30B, other obstacles, no-entry area, or the like and in which double parking is performed. Accordingly, the parking availability determination unit 16 may determine whether double parking of the vehicle 30 into the vacant parking space 51a is possible based on the length L2 and the width W2 of the vacant parking space 51a and the vehicle length L0 and the vehicle width W0 of the vehicle 30. In this case, the parking availability determination unit 16 derives a moving range of when the vehicle 30 performs double parking. In the example illustrated in FIG. 8, the vehicle 30 moves along a route indicated by a dashed-dotted line when performing double parking into the vacant parking space 51a. In order that the vehicle 30 may move along the moving route, it is necessary that there is no obstacle for movement in a necessary range along the moving route, that is, in the moving range. The parking availability determination unit 16 determines whether parking into the vacant parking space 51a is possible based on whether double parking may be performed without the derived moving range interfering with the other vehicles 30A and 30B, other obstacles, or no-entry area.

Moreover, the parking availability determination unit 16 may further determine whether the vehicle 30 may be parked in the vacant parking space 51a based on skill of a driver of the vehicle 30. In this case, in addition to the above-described determination whether parking is possible based on a width of the vacant parking space 51a, and a size and a moving range of the vehicle 30, the parking availability determination unit 16 determines whether parking is possible based on user information including skill information of a user that is the driver of the vehicle 30. More specifically, first, based on the skill information, the parking availability determination unit 16 derives a moving range of when the driver driving the vehicle 30 performs double parking. Next, the parking availability determination unit 16 determines whether double parking into the vacant parking space 51a may be performed without the derived moving range interfering with the other vehicles 30A and 30B, other obstacles, or no-entry area. Accordingly, the parking availability determination unit 16 may determine whether the vehicle 30 may be parked in the vacant parking space 51a based on driving skill of the user that drives the vehicle 30.

On the other hand, the parking availability determination unit 16 may determine whether the vehicle 30 may be parked into the vacant parking space 51a based on skill of drivers of the other vehicles 30A and 30B. In this case, in addition to the above-described determination whether parking is possible based on a width of the vacant parking space 51a, and a size and a moving range of the vehicle 30, the parking availability determination unit 16 determines whether parking is possible based on parking schedule information of the other vehicles 30A and 30B.

More specifically, first, the parking availability determination unit 16 derives a range in which the vehicle 30 may be parked in the vacant parking space 51a. In the example illustrated in FIG. 8, a position in which the vehicle 30 may be parked is that a left side portion of the vehicle 30 is to a position of a right side portion of the other vehicle 30A and a right side portion of the vehicle 30 is to a left side portion of the other vehicle 30B. In this case, for example, when the vehicle 30 is parked in such a manner that the right side portion thereof is placed extremely close to the left side portion of the other vehicle 30B, a door of the other vehicle 30B may not be opened while the vehicle 30 is parked, and it may be difficult for a user of the other vehicle 30B to get in the vehicle.

Thus, the parking availability determination unit 16 compares scheduled departure time included in the parking schedule information of the vehicle 30 with scheduled departure time included in the parking schedule information of the other vehicle 30A. In a case where the scheduled departure time of the vehicle 30 is before the scheduled departure time of the other vehicle 30B, the parking availability determination unit 16 may determine that a range available for parking is to a position extremely close to the left side portion of the other vehicle 30B. On the contrary, in a case where the scheduled departure time of the vehicle 30 is later than the scheduled departure time of the other vehicle 30A, the parking availability determination unit 16 first derives an opening/closing operation range of the door when the other vehicle 30B departs. Based on the derived opening/closing operation range of the door, the parking availability determination unit 16 may determine that the parking available range is to a position that does not interfere with the opening/closing operation range of the door of the other vehicle 30B. In the example illustrated in FIG. 8, the parking availability determination unit 16 sets, for example, a vehicle position 30m as the rightmost side of the parking range.

Similarly, the parking availability determination unit 16 determines a range available for parking of the vehicle 30 based on the parking schedule information of each of the vehicle 30 and the other vehicle 30A. In the example illustrated in FIG. 8, the other vehicle 30A may be started forward while getting in the vehicle with a door open is possible. Thus, the range available for parking of the vehicle 30 may be set to the position of the right side portion of the other vehicle 30A. Note that in a case where the other vehicle 30A is a vehicle in which getting into the vehicle is performed from the right side, it may be determined that the range available for parking is to a position that does not interfere with an opening/closing operation range of a door on the right side of the other vehicle 30A. In the example illustrated in FIG. 8, the parking availability determination unit 16 sets a vehicle position 30h as the leftmost side of the range available for parking, for example. In such a manner, the parking availability determination unit 16 compares the scheduled departure time of the vehicle 30 and that of the other vehicle 30A, and determines to which position the parking available range is set.

Similarly to the case of parallel parking, the parking availability determination unit 16 may derive moving ranges of the other vehicles 30A and 30B and determine a range available for parking so as not to interfere with these moving ranges. In this case, the parking availability determination unit 16 may further derive a moving range of each of the other vehicles 30A and 30B based on skill information of each of the drivers that drive the other vehicles 30A and 30B. The above-described vehicle positions 30h and 30m also become different positions according to the moving range based on the skill information of the drivers of the other vehicles 30A and 30B. In a case where the vehicle 30 and the other vehicles 30A and 30B are vehicles capable of autonomous traveling or autonomous parking, the skill information may not be employed, or setting information by autonomous driving may be employed instead of the skill information. The other methods are the similar to the parking position retrieval method described above.

According to the embodiment described above, it is possible to determine whether a parking position is where an own vehicle may be parked based on dimensions of the vehicle. Thus, in an area such as a certain road on which parking is permitted or a vacant lot, a user may promptly recognize a parking available area suitable for the own vehicle that a user is in. Moreover, even in a case where the other vehicles 30A and 30B are parked around the vacant parking spaces 50a and 51a, it is possible to determine whether parking is possible based on the scheduled departure time of the other vehicles 30A and 30B. Since it is determined whether parking is possible based on driving skill of a user of the vehicle 30, in a case where the driving skill of the user is immature, vacant parking spaces 50a and 51a and the like having narrow parking areas may be excluded from vacant parking spaces available for parking. Retrieval of a parking area by the parking position retrieval server may be applied to an area where parallel parking is possible or an area where double parking is possible.

Although an embodiment of the present disclosure has been described above in detail, the present disclosure is not limited to the above-described embodiment, and various modifications based on a technical idea of the present disclosure may be made. For example, the numerical values mentioned in the above-described embodiment are merely examples, and different numerical values may be used when necessary.

In the above-described embodiment, the parking position retrieval server 10 executes the functions of the area information generation unit 14, the parking position retrieval unit 15, the parking availability determination unit 16, and the route information generation unit 17. However, a control unit 32 of a vehicle 30 may execute a part or all of these functions. Similarly, a control unit 41 of a user terminal device 40 may execute a part or all of the functions of the area information generation unit 14, the parking position retrieval unit 15, the parking availability determination unit 16, and the route information generation unit 17.

Moreover, as another embodiment, each of functions of an area information generation unit 14, a parking position retrieval unit 15, a parking availability determination unit 16, and a route information generation unit 17 may be divided and executed by a plurality of devices that may communicate with each other via a network 2. For example, at least a part of the function of the area information generation unit 14 may be executed by a first device having a first processor. At least a part of the function of the parking availability determination unit 16 may be executed by a second device having a second processor. At least a part of the function of the parking position retrieval unit 15 may be executed by a third device having a third processor. At least a part of the function of the route information generation unit 17 may be executed by a fourth device having a fourth processor. Here, the first to fourth devices may be configured to be capable of transmitting and receiving information to and from each other via the network 2 or the like. In this case, at least one of the first to fourth devices, for example, the third device may be mounted on the vehicle 30.

In the embodiment described above, a program capable of executing a parking area retrieval method may be recorded in a recording medium that may be read by a computer or other machines or devices (hereinafter referred to as computer or the like). The computer or the like is caused to read and execute the program in the recording medium and the computer or the like functions as a parking position retrieval server 10 or a control unit of a vehicle 30. Here, the recording medium that may be read by the computer or the like indicates a non-transitory recording medium that may accumulate information such as data and a program by an electrical, magnetic, optical, mechanical, or chemical action and that may be read by the computer or the like. Examples of such a recording medium that may be removed from the computer or the like include a flexible disk, a magneto-optical disk, a CD-ROM, a CD-R/W, a DVD, a BD, a DAT, a magnetic tape, a memory card such as a flash memory, and the like. Moreover, recording media fixed to the computer or the like include a hard disk, a ROM, and the like. Moreover, a solid state drive (SSD) may be used as a recording medium removable from the computer or the like, and also as a recording medium fixed to the computer or the like.

Moreover, in the parking position retrieval system 1 according to the embodiment, the above-described “unit” may be also read as a “circuit” or the like. For example, the communication unit may be read as a communication circuit.

Moreover, a program to be executed by the information processing device according to the embodiment is provided as file data in an installable or executable format while being recorded in a computer-readable recording medium such as a CD-ROM, a flexible disk (FD), a CD-R, a digital versatile disk (DVD), a USB medium, or a flash memory.

Moreover, the program to be executed by the information processing device according to the embodiment may be stored in a computer connected to a network such as the Internet and provided by being downloaded through the network.

Note that in the description of the flowcharts in the present description, although the expressions “first”, “then”, “subsequently”, and the like are used to clarify processing order of the steps, the processing order required to carry out the present embodiment is not defined uniquely by these expressions. That is, the processing order in the flowcharts described in the present description may be changed in a range without contradiction.

According to the present disclosure, it becomes possible to promptly retrieve a parking available area suitable for a vehicle, on which a user rides, in an area where parking is permitted such as a certain road or a vacant lot (or an open space).

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a processor comprising hardware, the processor being configured to:
acquire a plurality of pieces of area information from a sensor;
acquire, in response to a request signal received from at least one of a user terminal associated with a user of a vehicle and a communication terminal associated with the vehicle, vehicle information including dimension information of the vehicle; and
select, from the plurality of pieces of area information based on the vehicle information, area information indicating a position where the vehicle can be parked.

2. The information processing device according to claim 1, wherein the processor is configured to:
search for a route to the position included in the selected area information; and
transmit the found route to the user terminal or the communication terminal.

3. The information processing device according to claim 1, wherein the processor is configured to:
acquire other-vehicle traveling information including scheduled departure time at which another vehicle parked at the position will depart; and
select, based on the other-vehicle traveling information, the area information indicating the position where the vehicle can be parked.

4. The information processing device according to claim 3, wherein the processor is configured to:
acquire own-vehicle traveling information including scheduled departure time at which the vehicle departs after parking; and
select, based on a comparison between the other-vehicle traveling information and the own-vehicle traveling information, the area information indicating the position where the vehicle can be parked.

5. The information processing device according to claim 1, wherein the processor is configured to:
acquire own-vehicle skill information related to driving skill of the user of the vehicle; and
select, based on the own-vehicle skill information, area information to be presented to the user from the selected area information.

6. The information processing device according to claim 1, wherein the processor is configured to:
acquire other-vehicle skill information related to driving skill of a user of another vehicle parked at the position where the vehicle can be parked, and
select, based on the other-vehicle skill information, area information to be presented to the user of the vehicle from the selected area information.

7. The information processing device according to claim 1, wherein the position where the vehicle can be parked is at least one of: a part on a road shoulder side on a road; and a part of a predetermined area on the road.

8. An information processing system comprising:
a first device comprising a first processor comprising hardware, the first processor being configured to acquire a plurality of pieces of area information from a sensor;
a second device comprising a second processor comprising hardware, the second processor being configured to acquire vehicle information including a dimension of a vehicle in response to a request signal received from at least one of a user terminal associated with a user of the vehicle and a communication terminal associated with the vehicle; and
a third device comprising a third processor comprising hardware, the third processor being configured to select, from the plurality of pieces of area information based on the vehicle information, area information indicating a position where the vehicle can be parked.

9. The information processing system according to claim 8, further comprising a fourth device comprising a fourth processor comprising hardware, the forth processor being configured to:
search for a route to the position included in the selected area information; and
transmit the found route to the user terminal or the communication terminal.

10. The information processing system according to claim 8, wherein the third processor is configured to:
acquire other-vehicle traveling information including scheduled departure time at which another vehicle parked at the position will depart; and
select, based on the other-vehicle traveling information, the area information indicating the position where the vehicle can be parked.

11. The information processing system according to claim 10, wherein the third processor is configured to:
acquire own-vehicle traveling information including scheduled departure time at which the vehicle departs after parking; and
select, based on a comparison between the other-vehicle traveling information and the own-vehicle traveling information, the area information indicating the position where the vehicle can be parked.

12. The information processing system according to claim 8, wherein the third processor is configured to:
acquire own-vehicle skill information related to driving skill of the user of the vehicle; and
select, based on the own-vehicle skill information, area information to be presented to the user from the selected area information.

13. The information processing system according to claim 8, wherein the third processor is configured to:
acquire other-vehicle skill information related to driving skill of a user of another vehicle parked at the position where the vehicle can be parked, and
select, based on the other-vehicle skill information, area information to be presented to the user of the vehicle from the selected area information.

14. The information processing system according to claim 8, wherein the third device is provided in the vehicle.

15. The information processing system according to claim 8, wherein the position where the vehicle can be parked is at least one of: a part on a road shoulder side on a road; and a part of a predetermined area on the road.

16. A non-transitory computer-readable recording medium on which an executable program is recorded, the program instructing a processor to execute:
acquiring a plurality of pieces of area information from a sensor;
acquiring, in response to a request signal received from at least one of a user terminal associated with a user of a vehicle and a communication terminal associated with the vehicle, vehicle information including dimension information of the vehicle; and
selecting, from the plurality of pieces of area information based on the vehicle information, area information indicating a position where the vehicle can be parked.

17. The recording medium according to claim 16, wherein the program instructs the processor to execute:
searching for a route to the position included in the selected area information; and
transmitting the found route to the user terminal or the communication terminal.

18. The recording medium according to claim 16, wherein the program instructs the processor to execute:
acquiring other-vehicle traveling information including scheduled departure time at which another vehicle parked at the position will depart; and
selecting, based on the other-vehicle traveling information, the area information indicating the position where the vehicle can be parked.

19. The recording medium according to claim 18, wherein the program instructs the processor to execute:
acquiring own-vehicle traveling information including scheduled departure time at which the vehicle departs after parking; and
selecting, based on a comparison between the other-vehicle traveling information and the own-vehicle traveling information, the area information indicating the position where the vehicle can be parked.

20. The recording medium according to claim 16, wherein the program further instructs the processor to execute:
acquiring at least one of: own-vehicle skill information related to driving skill of the user of the vehicle; and other-vehicle skill information related to driving skill of a user of another vehicle parked at the position where the vehicle can be parked; and
selecting, based on the own-vehicle skill information or the other-vehicle skill information, area information to be presented to the user from the selected area information.
